(19) United States
(12) Patent Application Publication
(10) Pub. No.: US 2021/0379896 A1
(43) Pub. Date: Dec. 9, 2021

(54) INKJET RECORDING APPARATUS

(71) Applicant: Konica Minolta, Inc., Tokyo (JP)

(72) Inventor: Yohei ITO, Tokyo (JP)

(21) Appl. No.: 17/330,965

(22) Filed: May 26, 2021

(30) Foreign Application Priority Data
Jun. 9, 2020 (JP) 2020-099743

(51) Int. Cl. B41J 2/165

(52) U.S. Cl. CPC B41J 2/16538; B41J 2/16544

(57) ABSTRACT

An inkjet recording apparatus includes an inkjet head that ejects ink from a nozzle; and a cloth wipe unit that includes a woven cloth that wipes a nozzle surface in which an ejecting opening of the nozzle of the inkjet head is open. The ink attached to the nozzle surface is wiped by a relative sliding movement between the woven cloth and the nozzle surface. A mountain portion formed on a surface by a thread passing above a crossed thread of the woven cloth rubs against all of the ejecting openings during the sliding.

### CROSS-REFERENCE TO RELATED APPLICATIONS

The entire disclosure of Japanese Patent Application No 2020-099743 filed on Jun. 9, 2020 is incorporated herein by reference in its entirety.

### BACKGROUND

### Technological Field

The present invention relates to an inkjet recording apparatus.

### Description of the Related Art

Conventionally, there is an inkjet recording apparatus in which ink is ejected from a nozzle of an inkjet head, the ink is landed in the desired position of the recording medium, and the image is recorded. When the ink is attached to a nozzle surface where an ejecting opening of the nozzle of the inkjet head is open, the attached ink thickens in a state covering a part of the ejecting opening of the nozzle, and then becomes solid. With this, failure in ejecting the ink may occur.

In order to wipe ink remaining on the nozzle surface, a cloth wiping method in which a woven cloth and the nozzle surface slide relatively to each other so that the cloth wipes the nozzle surface and a cleaning apparatus are known and used (JP 6162344 and JP 2018-79619).

### SUMMARY

However, the above conventional technique cannot solve the following problems.

FIG. 4A to FIG. 4C and FIG. 5 show a configuration of the structure of a plain woven cloth. As shown in FIG. 4A to FIG. 4C and FIG. 5, when a surface of the fabric is observed, a mountain portion m is formed on a surface by a warp a passing over a weft b. A mountain portion m is formed on a surface by the weft b passing over the warp a. Between the aligned weft b and weft b, a valley portion va and a space are continuously formed aligned with the weft b, and there is a position in which the mountain portion m is not provided. Between the aligned warp a and warp a, a valley portion vb and a space are continuously formed aligned with the warp a, and there is a position in which the mountain portion m is not provided.

Therefore, even if the nozzle discharging opening n rubs a position where the valley and the space continues and the mountain portion is not provided, the thickened ink around the ejecting opening n cannot be sufficiently scraped off.

The present invention is made in view of the above problems of the conventional technique, and the purpose of the present invention is to decrease unwiped portions when the ink attached to the nozzle surface of the inkjet head is wiped by a woven cloth and to enhance cleanability.

To achieve at least one of the abovementioned objects, according to an aspect of the present invention, an inkjet recording apparatus reflecting one aspect of the present invention includes an inkjet head that ejects ink from a nozzle; and a cloth wipe unit that includes a woven cloth that wipes a nozzle surface in which an ejecting opening of the nozzle of the inkjet head is open, wherein, the ink attached to the nozzle surface is wiped by a relative sliding movement between the woven cloth and the nozzle surface, and a mountain portion formed on a surface by a thread passing above a crossed thread of the woven cloth rubs against all of the ejecting openings during the sliding.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a front view showing a head and a cloth wipe unit in an inkjet recording apparatus according to an embodiment of the disclosure;

FIG. 2 is a side view showing a head and a cloth wipe unit of the inkjet recording apparatus according to the embodiment;

FIG. 3 is a block diagram showing main operation elements of the inkjet recording apparatus according to the embodiment;

FIG. 4A to FIG. 4C show a plain woven cloth, and FIG. 4A shows a vertical cross-section view, FIG. 4B shows a plane view, and FIG. 4C shows a horizontal cross-section view;

FIG. 5 is a diagram showing a structure of a plain woven cloth;

FIG. 6A and FIG. 6B show a twill woven cloth, and FIG. 6A shows a plane view and FIG. 6B shows a horizontal cross-section view;

FIG. 7 is a diagram showing a structure of a twill woven cloth;

FIG. 8 is a diagram showing a structure of a satin woven cloth;

FIG. 9A to FIG. 9C are diagrams showing a woven cloth woven by one method of weaving with high irregularity and FIG. 9A shows a vertical cross-section view, FIG. 9B shows a structure diagram, and FIG. 9C shows a horizontal cross-section view;

FIG. 10 is a table showing a result evaluating scraping properties of ink and an intersecting angle between a warp and a sliding direction;

FIG. 11 is a table showing a result evaluating pressing force of a nozzle surface on a woven cloth, scraping properties of ink, and wearing of the nozzle surface;

FIG. 12 is a table showing a result evaluating density of weft, scraping properties of ink, and liquid absorption properties of the woven cloth;

FIG. 13 is a table showing a result evaluating a thickness of the woven cloth and stain of a backup member;

FIG. 14 is a table showing a result evaluating relative speed between the nozzle surface and the woven cloth, the scraping properties of ink, and the stain of the backup member; and

FIG. 15 is a cross-section diagram showing a split yarn.

### DETAILED DESCRIPTION OF EMBODIMENTS

An embodiment of the present invention is described with reference to the drawings. An embodiment of the present invention is described and the scope of the present invention is not limited by the description below.

Hereinafter, one or more embodiments of the present invention will be described with reference to the drawings. However, the scope of the invention is not limited to the disclosed embodiments.

### Overview of Inkjet Recording Apparatus

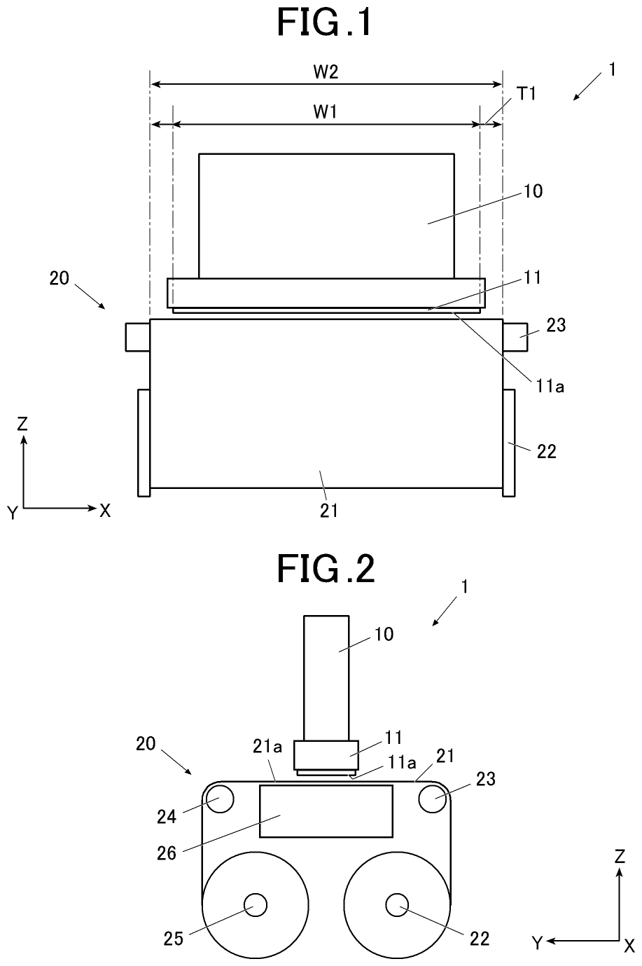

As shown in FIG. 1 and FIG. 2, the inkjet recording apparatus 1 includes an inkjet head 10 and a cloth wipe unit 20.

The inkjet head 10 ejects ink from a nozzle. The ejecting opening of the nozzle of the inkjet head 10 is open in a nozzle surface 11a of a nozzle plate 11 and a plurality of ejecting openings are aligned in the X-direction.

The cloth wipe unit 20 includes a woven cloth 21 which wipes the nozzle surface 11a. The cloth wipe unit 20 includes a wiping surface 21a of the woven cloth 21 on a XY surface parallel to the nozzle surface 11a. According to the present embodiment, the woven cloth 21 is a long cloth rolled in a roll. The woven cloth 21 is rolled out from a rolling out roller 22 and placed between supporting rollers 23 and 24 so as to form a wiping surface 21a at a predetermined position. After wiping, the woven cloth 21 is rolled in by a rolling in roller 25. On the back surface of the wiping surface 21a, a backup member 26 is positioned to oppose to pressing force from the nozzle surface 11a to the wiping surface 21a.

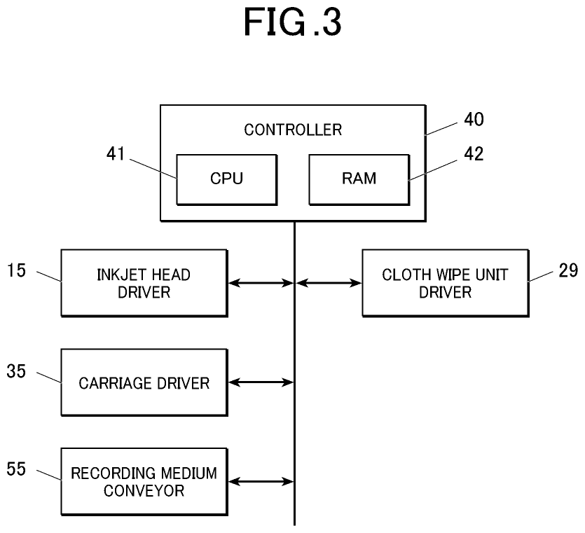

FIG. 3 shows a block diagram showing the main operation elements in the inkjet recording apparatus 1.

A controller 40 is a processor (hardware processor) which centrally controls the entire operation of the inkjet recording apparatus 1. The controller 40 includes, for example, a CPU 41 (Central Processing Unit) and a RAM 42 (Random Access Memory). The CPU 41 performs a calculating operation and performs various control processes. The RAM 42 provides a memory space for work to the CPU 41 and stores temporary data.

The inkjet head 10 is provided in a carriage and is able to move in an X-direction. The controller 40 controls an inkjet head driver 15, a carriage driver 35, and a recording medium conveyor 55 in order to perform a recording operation.

The controller 40 pauses the recording operation and controls the carriage driver 35 and a cloth wipe unit driver 29 in order to clean the nozzle surface 11a by wiping, and positions the inkjet head 10 as shown in FIG. 1 and FIG. 2 in a cloth wipe position. Although not illustrated in the diagram, the nozzle surface 11a is pressed against the wiping surface 21a at the cloth wipe position shown in FIG. 1 and FIG. 2. The pressing is performed by a lifting function of the carriage by the carriage driver 35 or the lifting function of the cloth wipe unit 20 by the cloth wipe unit driver 29.

In a state in which the nozzle surface 11a is pressed against the wiping surface 21a, the controller 40 controls the carriage driver 35 to execute the wiping operation to move the inkjet head 10 back and forth in the X-direction. This causes relative sliding between the woven cloth 21 and the nozzle surface 11a, and the ink attached to the nozzle surface 11a is wiped by the sliding.

In the sliding direction X, a dimension W2 of a woven cloth 21 exceeds a dimension adding a sliding distance T1 to a dimension W1 of a nozzle plate 11 including the nozzle surface 11a. According to the above conditions, the entire surface of the nozzle surface 11a is constantly in contact with the woven cloth 21 during the wiping operation, and the cleanability is enhanced.

### Applying Various Fabrics

Next, applying fabrics with various structures is described.

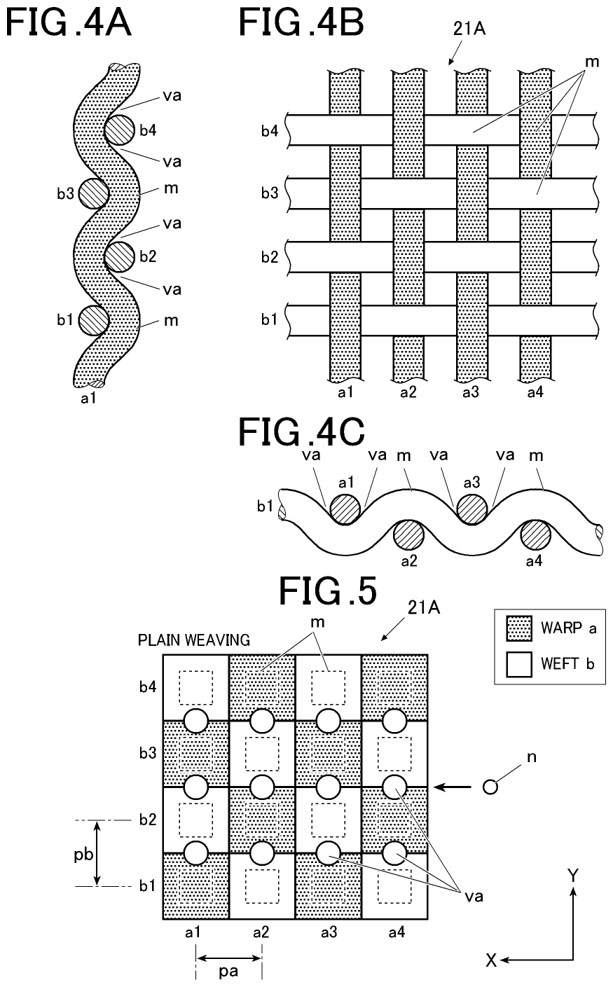

FIG. 4A to FIG. 4C show a woven cloth 21A woven by plain weaving (referred to as plain woven cloth 21A). FIG. 5 shows a diagram showing a structure of the plain woven cloth 21A. Warp is shown by a and weft is shown by b. A separate number is applied to each of the above. The pitch of the warp is shown by pa and the pitch of the weft is shown by pb. The same applies below.

A mountain portion m is formed on a surface by a thread passing above a crossed thread of the woven cloth 21A. The mountain portion m is at a center of a square in the structure diagram of FIG. 5.

In the woven cloth 21A, a valley portion v is formed on the surface by a thread passing from below to above or from above to below the crossed thread. Here, the crossed thread is the weft b in relation to the warp a and the crossed thread is the warp a in relation to the weft b. Therefore, the valley portion va is formed on the surface by the warp a passing from below to above or from above to below the weft b. The valley portion vb is formed on the surface by the weft b passing from below to above or from above to below the warp a. FIG. 5 shows the valley portion va formed on the surface by the warp a passing from below to above or from above to below the weft b marked with a white circle. It is possible to confirm that the valley portion va continues in the X-direction which is the sliding direction.

In the plain woven cloth 21A, the valley portion va (vb) is formed on the surface by the thread a (b) passing from below to above or from above to below the crossed thread b (a). The mountain portion m is not positioned in the position parallel to the crossed thread b (a), and the plain woven cloth 21A includes a structure in which the valley portion va (vb) continues.

As shown in FIG. 5, if the ejecting opening n of the nozzle slides at the position of such valley portion, the ink in the ejecting opening n and the portion surrounding the ejecting opening n cannot be sufficiently scraped.

In the inkjet recording apparatus 1, the mountain portion m rubs against all of the ejecting openings n when the wiping operation is performed. That is, after the wiping operation is performed, there is to be no ejecting opening n which is not rubbed by the mountain portion m.

When the plain woven cloth 21A is applied, during the wiping operation in which the nozzle surface 11a and the wiping surface 21a slide, the woven cloth 21A is sent a half pitch (½×pb) or more in the Y-direction. With this, it is possible to rub the mountain portion m against all of the ejecting openings n.

The controller 40 controls the carriage driver 35 and a cloth sender of the cloth wipe unit driver 29, and performs the wiping operation which executes the sliding in the X-direction and the cloth sending in the Y-direction.

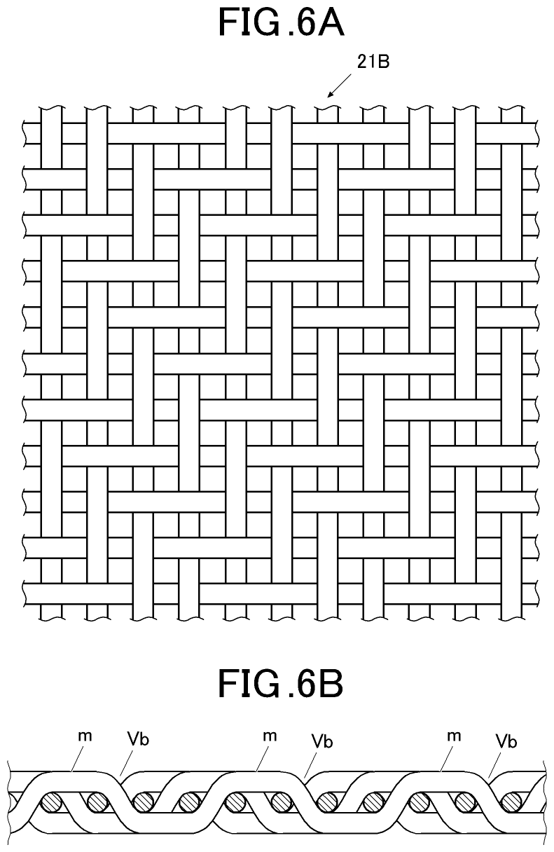

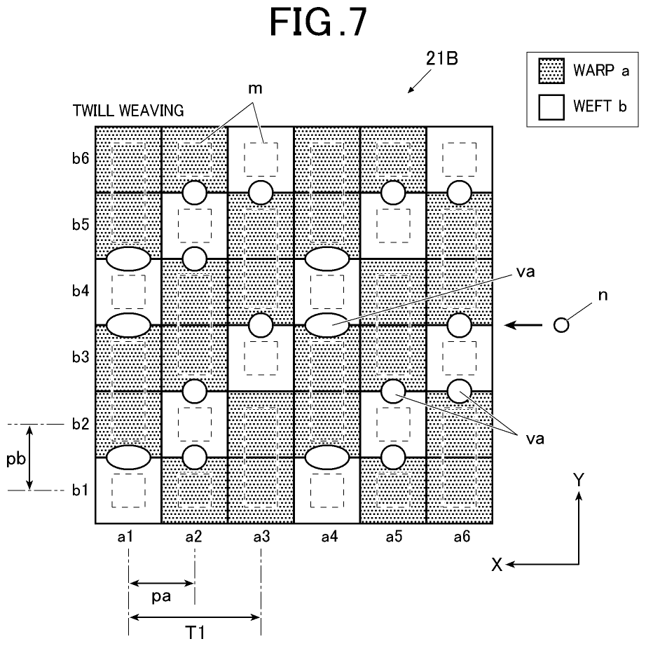

FIG. 6A and FIG. 6B shows a woven cloth 21B woven by twill weaving (referred to as twill woven cloth 21B). FIG. 7 shows a diagram showing a structure of the twill woven cloth 21B.

The twill woven cloth 21B shown in FIG. 6A and FIG. 6B and FIG. 7 includes a structure in which a valley portion va is formed on the surface by the thread a passing from below to above or from above to below the crossed thread b and a mountain portion m is positioned in a position parallel to the crossed thread b (this is to be structure condition 1).

Therefore, if the ejecting opening n of the nozzle as shown in FIG. 7 slides at the position of the valley portion va, the ejecting opening n also rubs the mountain portion m, and the ink in the ejecting opening n and the portion surrounding the ejecting opening n can be sufficiently scraped.

The inkjet recording apparatus 1 applies such twill woven cloth 21B and performs the wiping operation of the nozzle surface 11a by control of the controller 40 setting the weft direction X as the sliding direction.

In the sliding performed here, the sliding direction X is the direction intersecting with the warp a, and the sliding distance T1 is 2 pitches or more (2×pa) of the warp a, and the condition of the woven cloth 21B is that there is at least one mountain portion m by the warp a within the sliding distance T1.

FIG. 6A and FIG. 6B show 2/2 twill weaving, and FIG. 7 shows 2/1 twill weaving.

Since there is tension on the warp a due to supporting of the woven cloth 21 by the cloth wiping unit 20, the ink is scraped by the mountain portion of the warp a.

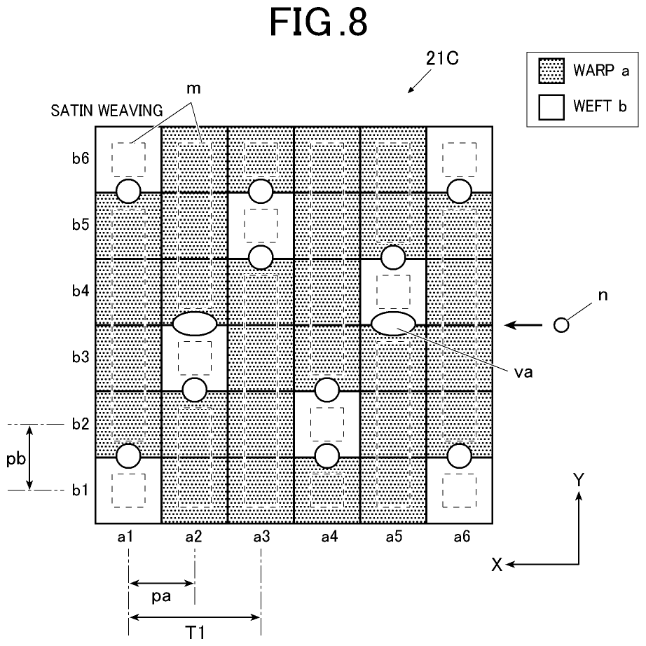

FIG. 8 shows a woven cloth 21C woven by satin weaving (referred to as satin woven cloth 21C).

The structure of the satin woven cloth 21C satisfies the structure condition 1.

Therefore, as shown in FIG. 8, if the ejecting opening n of the nozzle slides at the position of the valley portion va, the ejecting opening n also rubs the mountain portion m, and the ink in the ejecting opening n and the portion surrounding the ejecting opening n can be sufficiently scraped.

The inkjet recording apparatus 1 applies such satin woven cloth 21C and performs the wiping operation of the nozzle surface 11a by control of the controller 40 setting the weft direction X as the sliding direction.

In the sliding performed here, the sliding direction X is the direction intersecting with the warp a, and the sliding distance T1 is 2 pitches or more (2×pa) of the warp a, and the condition of the woven cloth 21C is that there is at least one mountain portion m by the warp a within the sliding distance T1.

Since there is tension on the warp a due to supporting of the woven cloth 21 by the cloth wiping unit 20, the ink is scraped by the mountain portion of the warp a.

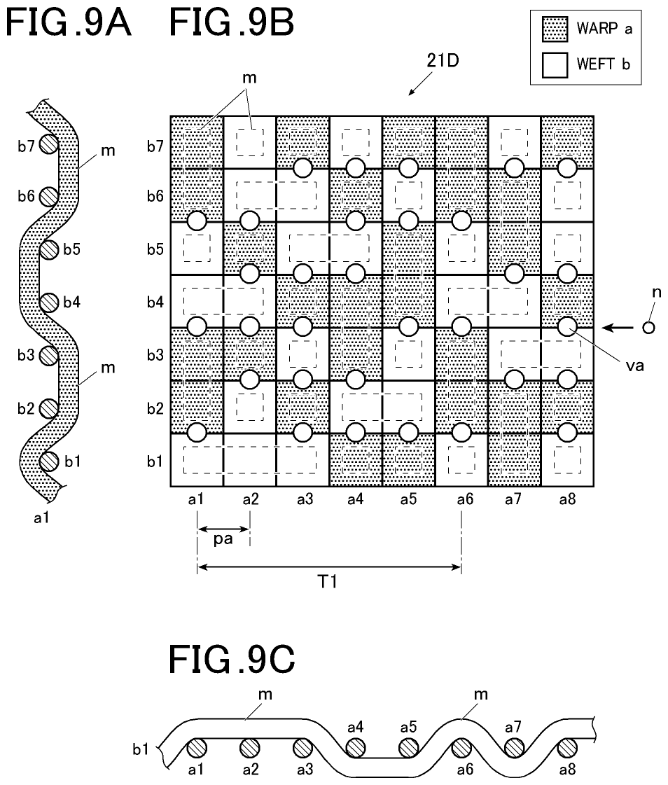

FIG. 9A to FIG. 9C show another woven cloth 21D.

The woven cloth 21D is a fabric which is highly irregular including an irregular structure in a range exceeding warp 5 threads×weft 5 threads. Such fabric which is highly irregular can also be applied.

The structure of the woven cloth 21D satisfies the structure condition 1.

Therefore, as shown in FIG. 9A to FIG. 9C, if the ejecting opening n of the nozzle slides at the position of the valley portion va, the ejecting opening n also rubs the mountain portion m, and the ink in the ejecting opening n and the portion surrounding the ejecting opening n can be sufficiently scraped.

The inkjet recording apparatus 1 applies such woven cloth 21D which is highly irregular and performs the wiping operation of the nozzle surface 11a by control of the controller 40 setting the weft direction X as the sliding direction.

In the sliding performed here, the sliding direction X is the direction intersecting with the warp a, and the sliding distance T1 is 2 pitches or more (2×pa) of the warp a, and the condition of the woven cloth 21D is that there is at least one mountain portion m by the warp a within the sliding distance T1. The sliding distance T1 is made suitably long according to the structure of the fabric so that the mountain portion m of the warp a rubs against all of the ejecting openings n.

Since there is tension on the warp a due to supporting of the woven cloth 21 by the cloth wiping unit 20, the ink is scraped by the mountain portion of the warp a.

As the woven cloth 21 of the cloth wipe unit 20 of the inkjet recording apparatus 1, the above woven cloths 21B to 21D are employed. In this case, there is no need to send cloth in the Y direction in the wiping operation, and even if the sliding is performed in any position, by setting the necessary sliding distance, the mountain portion of the warp a is always against the ejecting opening n of the nozzle, and the ink can be sufficiently scraped.

As described above, it is possible to reduce the remaining ink attached to the nozzle surface 11a of the inkjet head 10 when wiped by the woven cloth 21, and the cleanability is enhanced

### Various Evaluation Experiments

### (1) Intersecting Angle between Sliding Direction and Warp

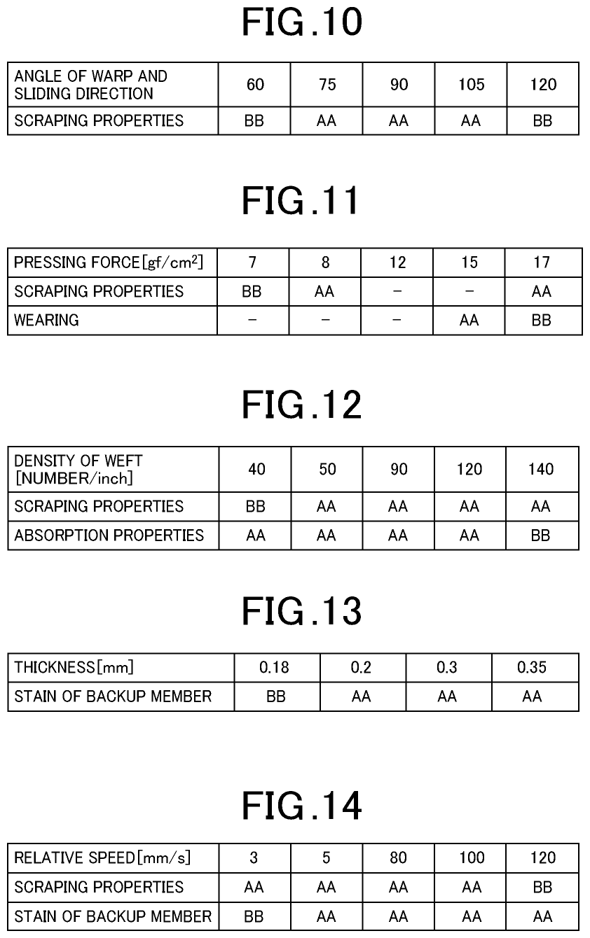

As shown in the table in FIG. 10, an evaluation is made regarding the intersecting angle between the sliding direction X and the warp a, and the scraping properties of the ink from the nozzle surface a.

Preferably, the intersecting angle between the sliding direction X and the warp A is within the range of 90 degrees±15 degrees.

As described above, the scraping properties are high if rubbed in the direction which is 90 degrees with relation to the warp a which forms a mountain portion in the wiping surface 21a. Since the scraping is performed with the warp a, the scraping properties decrease if shifted 15 degrees or more.

### (2) Pressing Force During Sliding

As shown in the table in FIG. 11, an evaluation is made regarding the pressing force to the woven cloth 21 of the nozzle surface 11a during sliding, the scraping properties of the ink from the nozzle surface 11a, and the wearing of the nozzle surface 11a.

Preferably, the pressing force to the woven cloth 21 of the nozzle surface 11a is 8 to 15 [gf/cm²].

If the pressing force is less than 8 [gf/cm²], the fiber of the woven cloth 21 is not pressed against the nozzle surface 11a with the sufficient pressing force and the scraping properties decrease. If the pressing force is more than 15 [gf/cm²], the wearing of the water-repellent film of the nozzle surface 11a is accelerated.

### (3) Density of Weft

As shown in the table in FIG. 12, an evaluation is made regarding the density of the weft b of the woven cloth 21, the scraping properties of the ink from the nozzle surface 11a, and the absorption properties of the woven cloth 21.

Preferably, the density of the weft b of the woven cloth 21 is within the range of 50 to 120 [number of threads/inch].

If the density of the weft b is less than 50 [number of threads/inch], the number of fibers against the nozzle surface 11a becomes less and the scraping properties decrease. If the density of the weft b is more than 120 [number of threads/inch], the space between the fibers decreases and capillarity decreases. This results in decrease of absorption properties.

### (4) Thickness of Woven Cloth

As shown in the table in FIG. 13, an evaluation is made regarding the thickness of the woven cloth 21 and stain on the backup member 26.

Preferably, the thickness of the woven cloth 21 is 0.2 [mm] or more.

If the thickness of the woven cloth 21 is less than 0.2 [mm], the ink cannot be absorbed and the backup member is stained.

### (5) Relative Speed of Nozzle Surface and Woven Cloth (Sliding Speed)

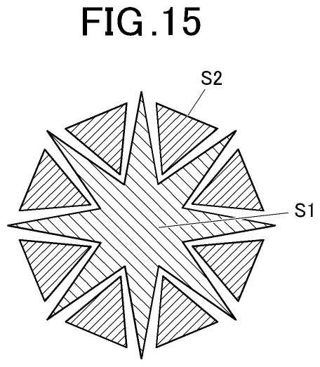

As shown in the table in FIG. 14, an evaluation is made regarding the relative speed of the nozzle surface 11a and the woven cloth 21 during sliding, the scraping properties of the ink from the nozzle surface 11a, and the stain on the backup member 26.

Preferably, the range of the relative speed of the nozzle surface 11a and the woven cloth 21 during sliding is within 5 to 100 [mm/s].

If the relative speed (sliding speed) is less than 5 [mm/s], too much ink is pulled out from the nozzle of the head 10 due to the capillarity of the woven cloth 21, and the backup member 26 is stained. If the relative speed is more than 100 [mm/s], the speed is too fast and the scraped ink cannot be absorbed by the woven cloth 21. Therefore, the scraping properties decrease.

### (6) Method of Evaluation

The method of evaluation is described below.

The scraping properties are evaluated by attaching a predetermined amount of ink on a PET film (dried at room temperature for five minutes), and then evaluating the appearance after wiping with the cloth once. The sliding speed is 50 [mm/s]. The pressing force is 15 [gf/cm²] if not specified.

The meaning of the marks showing the evaluation is as follows. AA: ink is completely wiped, BB: ink is slightly remaining, CC: ink is clearly remaining

The wearing is evaluated by how much the nozzle plate 11 around the ejecting opening of the nozzle is shaved after sliding the woven cloth 21, in which a weight is mounted, 1000 times against the nozzle surface 11a of the nozzle plate 11 used in the head 10. The sliding speed is to be 50 [mm/s].

The meaning of the marks showing the evaluation is as follows. AA: the portion around the nozzle ejecting opening is not shaved, BB: some portions around the nozzle ejecting opening are shaved, CC: it is clear that the portions around the nozzle ejecting opening are shaved.

The absorption properties are evaluated as follows. A predetermined amount of ink is attached on the PET film and the woven cloth 21 comes into contact with the PET film with a predetermined pressing force and for a predetermined amount of time. The amount of change of the ink weight before and after the above process is evaluated as the absorption rate.

The meaning of the marks showing the evaluation is as follows. AA: the absorption rate is 70% or more, BB: the absorption rate is 40 to 70%, CC: the absorption rate is 40% or less.

The stain on the backup member is evaluated as follows. After attaching a predetermined amount of ink to the nozzle surface 11a of the nozzle plate 11, and pressing the backup member 26 against the nozzle surface 11a with the woven cloth 21 in between, the woven cloth 21 is removed and the surface of the backup member 26 is observed for evaluation.

The meaning of the marks showing the evaluation is as follows. AA: there is no ink stain, BB: there is a slight ink stain, CC: there is a clear ink stain.

### Material of Thread and Split Fiber Which are Applied

As the thread using the woven cloth 21, polyester fiber thread or nylon fiber thread can be applied.

A split fiber thread including a cross section as shown in FIG. 15 can be applied as the thread used in the woven cloth 21. The split fiber thread as shown in FIG. 15 is a combination of two fibers S1 and S2. The nylon fiber is applied as the fiber S1, and the polyester fiber is applied as the fiber S2.

The split fiber thread includes two different materials which are the fibers S1 and S2. By performing a process to open the fiber, the fibers are split, and become fibers with a thin and distorted shape. Therefore, the absorption properties are enhanced by the thin fiber structure and the scraping properties are enhanced by the distorted shape fibers coming into contact with the nozzle surface 11a.

Although embodiments of the present invention have been described and illustrated in detail, the disclosed embodiments are made for purposes of illustration and example only and not limitation. The scope of the present invention should be interpreted by terms of the appended claims.

What is claimed is:

1. An inkjet recording apparatus comprising:
an inkjet head that ejects ink from a nozzle; and
a cloth wipe unit that includes a woven cloth that wipes a nozzle surface in which an ejecting opening of the nozzle of the inkjet head is open, wherein,
the ink attached to the nozzle surface is wiped by a relative sliding movement between the woven cloth and the nozzle surface, and
a mountain portion formed on a surface by a thread passing above a crossed thread of the woven cloth rubs against all of the ejecting openings during the sliding.

2. The inkjet recording apparatus according to claim 1, wherein the woven cloth includes a structure in which a valley portion is formed on the surface by a thread passing from below to above or from above to below the crossed thread and the mountain portion is positioned in a position parallel to the crossed thread.

3. The inkjet recording apparatus according to claim 2, wherein the woven cloth includes an irregular structure in a range exceeding five warp and five weft.

4. The inkjet recording apparatus according to claim 2, wherein a direction of the sliding is a direction intersecting with a warp, a distance of the sliding is two or more pitches of the warp, and the woven cloth includes at least one mountain portion by the warp within the distance of the sliding.

5. The inkjet recording apparatus according to claim 1, wherein an intersecting angle between a direction of the sliding and the warp of the woven cloth is within a range of 90 degrees±15 degrees.

6. The inkjet recording apparatus according to claim 1, wherein a pressing force of the nozzle surface to the woven cloth during the sliding is 8 to 15 [gf/cm²].

7. The inkjet recording apparatus according to claim 1, wherein a density of a weft of the woven cloth is within a range of 50 to 120 [threads/inch].

8. The inkjet recording apparatus according to claim 1, wherein a thickness of the woven cloth is 0.2 [mm] or more.

9. The inkjet recording apparatus according to claim 1, wherein material of the thread used in the woven cloth is polyester or nylon.

10. The inkjet recording apparatus according to claim 1, wherein the thread used in the woven cloth is a split fiber thread.

11. The inkjet recording apparatus according to claim 10, wherein the split fiber includes polyester and nylon.

12. The inkjet recording apparatus according to claim 1, wherein a relative speed of the nozzle surface and the woven cloth during sliding is within a range of 5 to 100 [mm/s].

13. The inkjet recording apparatus according to claim 1, wherein, in a direction of the sliding, a dimension of the woven cloth exceeds a dimension in which a distance of the sliding is added to a dimension of a nozzle plate including the nozzle surface.
